(19) United States
(12) Patent Application Publication
(10) Pub. No.: US 2018/0100697 A1
(43) Pub. Date: Apr. 12, 2018

(54) GLASS HEATING FURNACE AND GLASS

(71) Applicant: TUNG CHANG MACHINERY AND ENGINEERING CO., LTD., Taoyuan (TW)

(72) Inventor: CHUNG-HSIEH KANG, Taoyuan (TW)

(21) Appl. No.: 15/291,207

(22) Filed: Oct. 12, 2016

(51) Int. Cl. F27B 9/14; C03B 27/00

(52) U.S. Cl. CPC F27B 9/145; F27B 2009/3607; C03B 27/00

(57) ABSTRACT

A glass heating furnace is disclosed. The glass heating furnace allows glass to be heated up more uniformly, which reduces effectively the formation of the thermal stress marks on the glass. The glass heating furnace uses primarily a roller power module to control the rollers to displace reciprocatively, allowing the glass to be heated up uniformly and reducing significantly the formation of the thermal stress marks in the heating process of the glass, through the reciprocative displacement of the rollers. A glass is made by the glass heating furnace. The glass displaces in a chamber of the glass heating furnace along an S-shaped moving path or an 8-shaped moving path.

### BACKGROUND OF THE INVENTION

### a) Field of the Invention

The present invention relates to a glass heating furnace and glass, and more particularly to a glass heating furnace and glass allowing the glass to be heated up more uniformly, thereby reducing effectively the thermal stress marks which are formed on the glass.

### b) Description of the Prior Art

Glass is equipped with the excellent permeability and is scratch-proofed. Therefore, glass is widely used in a daily life, such as buildings and general articles for daily use. Furthermore, even in electronic products or vehicles, there are related glass products. Accordingly, it is apparently that the glass-related merchandises have already been everywhere in the people's life.

Glass is mostly made by the procedure of dosing, melting, forming and annealing. After making glass, glass can be also processed by an automatic apparatus such as a glass heating furnace. Glass is heated up by the glass heating furnace to improve the strength.

Referring to FIG. 1 and FIG. 2, a conventional glass heating furnace includes a chamber which is provided with plural upper heating elements 1 and lower heating elements 2 aligned symmetrically at an upper and lower position. In addition, plural rollers 3 are disposed between the upper heating elements 1 and the lower heating elements 2 to carry glass A. The glass A stays in the chamber for a fixed time at a fixed position and is heated up by the thermal radiation from the upper heating elements 1 and the lower heating elements 2. After being heated up for the fixed time at the fixed position, the glass A is driven by a roller power module 4 to be transmitted out of the chamber, and is then cooled down rapidly, thereby improving the strength. However, when the glass A receives the thermal radiation, the molecules in the glass will displace microscopically to be realigned and stacked with one another. Hence, if the glass A does not move at that fixed position, a part in the glass A directly below the upper heating elements 1 and directly above the lower heating elements 2 will be irradiated by the upper heating elements 1 and the lower heating elements 2 directly, resulting in a higher temperature at that part. This enables the glass molecules at that part to displace more easily and to be realigned and stacked with one another more tightly. On the other hand, for other area on the glass A which is not irradiated by the upper heating elements 1 and the lower heating elements 2 directly, such as the area that is not directly below the upper heating elements 1 and not directly above the lower heating elements 2, the temperature is lower in comparison with the part that is irradiated by the upper heating elements 1 and the lower heating elements 2 directly. This allows the glass molecules at that area to displace less easily and to be less easily realigned and stacked with one another, so that the molecules will be stacked less tightly comparing to the part that is irradiated by the upper heating elements 1 and the lower heating elements 2 directly. As the molecules are stacked more tightly at that part, the density in that part is higher; whereas, as the molecules are stacked less tightly at that area, the density in that area is lower. Therefore, the thermal stress marks will be formed by the heating due to the difference in density in the abovementioned two portions, and the refractive index will be different due to the difference in density. In addition, when light passes through the glass, the thermal stress marks in the glass can be identified visually due to the angle of refraction, thereby affecting the quality of uniformity for a same piece of glass.

### SUMMARY OF THE INVENTION

Accordingly, the primary object of the present invention is to provide a glass heating furnace and glass that allow the glass to be heated up more uniformly, thereby reducing effectively the thermal stress marks which are formed on the glass. In the present invention, a roller power module is used primarily to control the rollers to displace reciprocatively, so that the glass can be heated up uniformly through the reciprocative displacement of the rollers, thereby reducing significantly the formation of the thermal stress marks in the heating process of the glass.

According to an object of the present invention, a glass heating furnace is disclosed, including at least a furnace body, an interior of which is formed with a chamber; plural upper heating elements which are disposed in the chamber, with the center of one upper heating element being separated with the center of a neighboring upper heating element by a first distance; plural lower heating elements which are disposed in the chamber and are located oppositely below the upper heating elements, with the center of one lower heating element being separated with the center of a neighboring lower heating element by a second distance; plural rollers which are disposed in the chamber along a transversal axis and are located between the upper heating elements and the lower heating elements, with the transversal axis being perpendicular to a longitudinal axis which is the axis of the rollers; and a first roller power module which is disposed outside the furnace body and is connected with the rollers, with the first roller power module controlling the rollers to displace reciprocatively between two pre-determined positions along the longitudinal axis.

In accordance with the abovementioned technical features, the distance between the said two pre-determined positions is at least one fourth of the first distance or at least one fourth of the second distance, allowing the heated area of glass to be increased uniformly by at least one fourth.

In accordance with the abovementioned technical features, the distance between the said two pre-determined positions is at least one third of the first distance or at least one third of the second distance, allowing the heated area of glass to be increased uniformly by at least one third.

In accordance with the abovementioned technical features, the distance between the said two pre-determined positions is at least one half of the first distance or at least one half of the second distance, allowing the heated area of glass to be increased uniformly by at least one half.

In accordance with the abovementioned technical features, the distance between the said two pre-determined positions is not smaller than the first distance or not smaller than the second distance, allowing the heated area of glass to be increased uniformly to the whole glass area.

In accordance with the abovementioned technical features, the said first roller power module includes at least a moving mechanism and a moving frame. The moving mechanism is disposed on the moving frame, the moving frame is connected with the rollers, and the moving mechanism includes a motor which can rotate clockwise and counterclockwise as well as a decelerator which can reduce the rotating speed and increase the torque.

In accordance with the abovementioned technical features, the said motor which can rotate clockwise and counterclockwise as well as the decelerator which can reduce the rotating speed and increase the torque push the moving frame to displace reciprocatively along the longitudinal axis, so as to drive the rollers which are connected with the moving frame to displace reciprocatively along the longitudinal axis, enabling the glass which is carried by the rollers to displace reciprocatively along the longitudinal axis that the heated area of the glass can be increased uniformly.

In accordance with the abovementioned technical features, the said first roller power module includes at least a moving mechanism and a moving frame. The moving frame is connected with the rollers, the moving mechanism includes a motor as well as a decelerator, and the moving mechanism and the moving frame are connected by a slide assembly.

In accordance with the abovementioned technical features, the said moving mechanism and the slide assembly push the moving frame to displace reciprocatively along the longitudinal axis, which drives the rollers which are connected with the moving frame to displace reciprocatively along the longitudinal axis and therefore enables the glass which is carried by the rollers to displace reciprocatively along the longitudinal axis that the reciprocative stroke can be adjusted and changed, thereby increasing the heated area of the glass uniformly.

In accordance with the abovementioned technical features, the said first roller power module further includes a slide assembly which is connected with the moving frame and the furnace body.

In accordance with the abovementioned technical features, the said slide assembly includes a threaded rod and a threaded block, the threaded rod and the threaded block can be gnawed with each other, and the axis of the threaded rod is the longitudinal axis.

In accordance with the abovementioned technical features, the said threaded rod is fixed with the furnace body.

In accordance with the abovementioned technical features, the said threaded block is fixed with the furnace body.

In accordance with the abovementioned technical features, the said glass heating furnace further includes a second roller power module which is disposed outside the furnace body and is connected with the rollers.

In accordance with the abovementioned technical features, the said second roller power module includes a turning gear, plural transmission wheels and plural round belts. The turning gear is connected with one transmission wheel, and the transmission wheels are connected with one another by the round belts. At least one transmission wheel is connected with the rollers. In addition, the turning gear can rotate clockwise and counterclockwise, driving the glass to displace reciprocatively along the transverse axis.

In accordance with the abovementioned technical features, the said rollers are parallel or perpendicular to the upper heating elements or the lower heating elements.

In accordance with the abovementioned technical features, the said rollers are perpendicular to the upper heating elements and the lower heating elements.

According to another object of the present invention, glass is disclosed and is made by the glass heating furnace with the abovementioned technical features.

In accordance with the abovementioned technical features, the moving path of the said glass in the chamber is like an English letter of S, so that the glass can be heated up uniformly.

In accordance with the abovementioned technical features, the moving path of the said glass in the chamber is like a number of 8, so that the glass can be heated up uniformly.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a first schematic view of a conventional glass heating furnace.

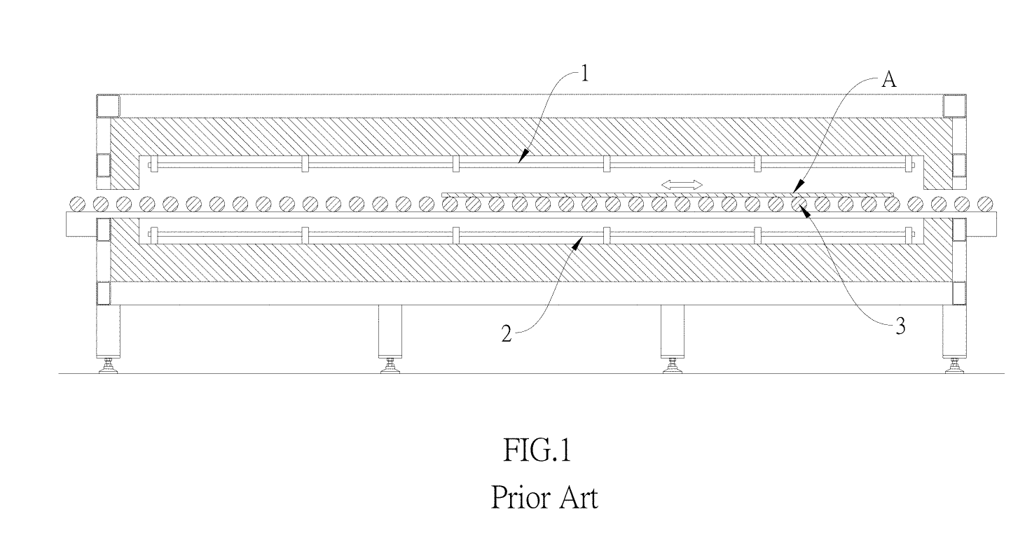

FIG. 2 shows a second schematic view of the conventional glass heating furnace.

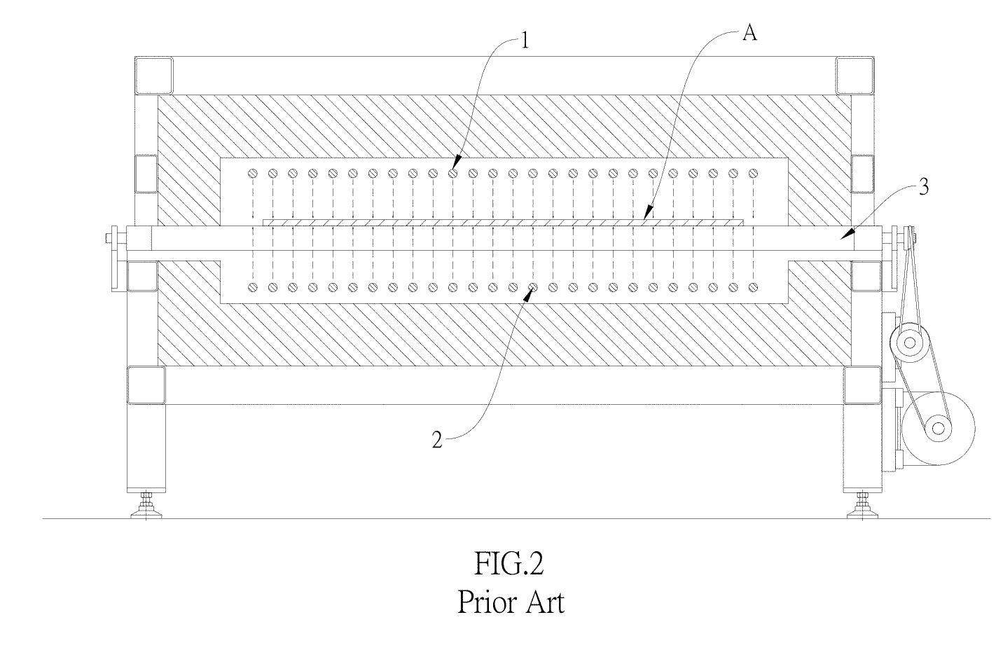

FIG. 3 shows a first schematic view of an embodiment of the glass heating furnace, according to the present invention.

FIG. 4 shows a second schematic view of the embodiment of the glass heating furnace, according to the present invention.

FIG. 5 shows a third schematic view of the embodiment of the glass heating furnace, according to the present invention.

FIG. 6 shows a fourth schematic view of the embodiment of the glass heating furnace, according to the present invention.

FIG. 7 shows a fifth schematic view of the embodiment of the glass heating furnace, according to the present invention.

FIG. 8 shows a sixth schematic view of the embodiment of the glass heating furnace, according to the present invention.

FIG. 9 shows a schematic view of an S-shaped moving path of the glass, according to the embodiment of the glass heating furnace of the present invention.

FIG. 10 shows a schematic view of an 8-shaped moving path of the glass, according to the embodiment of the glass heating furnace of the present invention.

### DETAILED DESCRIPTION OF THE PREFERRED EMBODIMENTS

In order to facilitate the examiner to understand the technical features, the contents and the advantages of the present invention, as well as the efficacy that can be reached by the present invention, the present invention will now be described in detail with the drawings and the form of expression of the embodiment. The drawings used are only for illustration and support of the specification; and hence are not necessarily accurate in scale and precise in configuration after implementation of the present invention. Therefore, it should not be interpreted based upon the scale and the configuration on the drawings to confine the scope of the rights claimed on the practical implementation of the present invention.

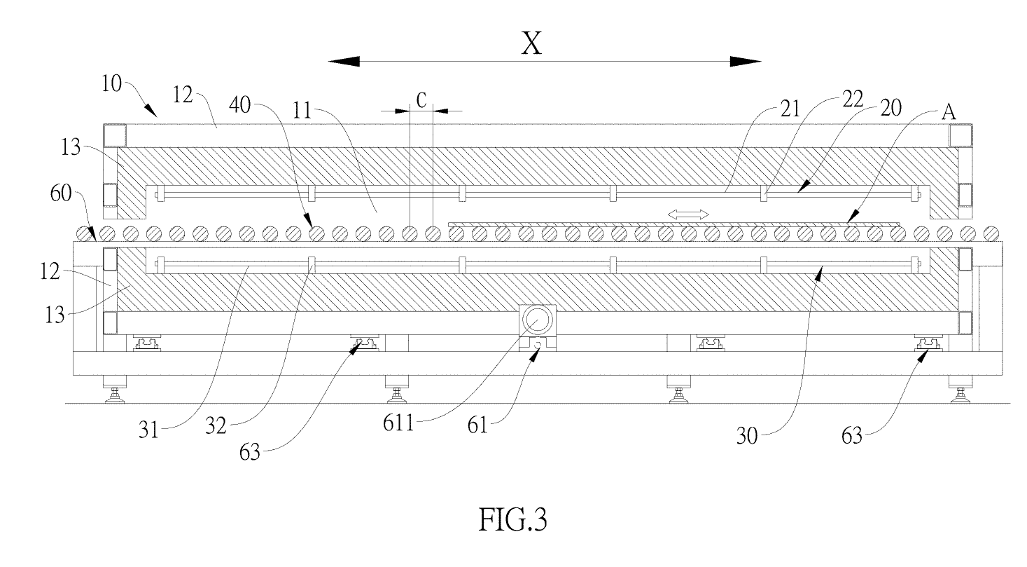

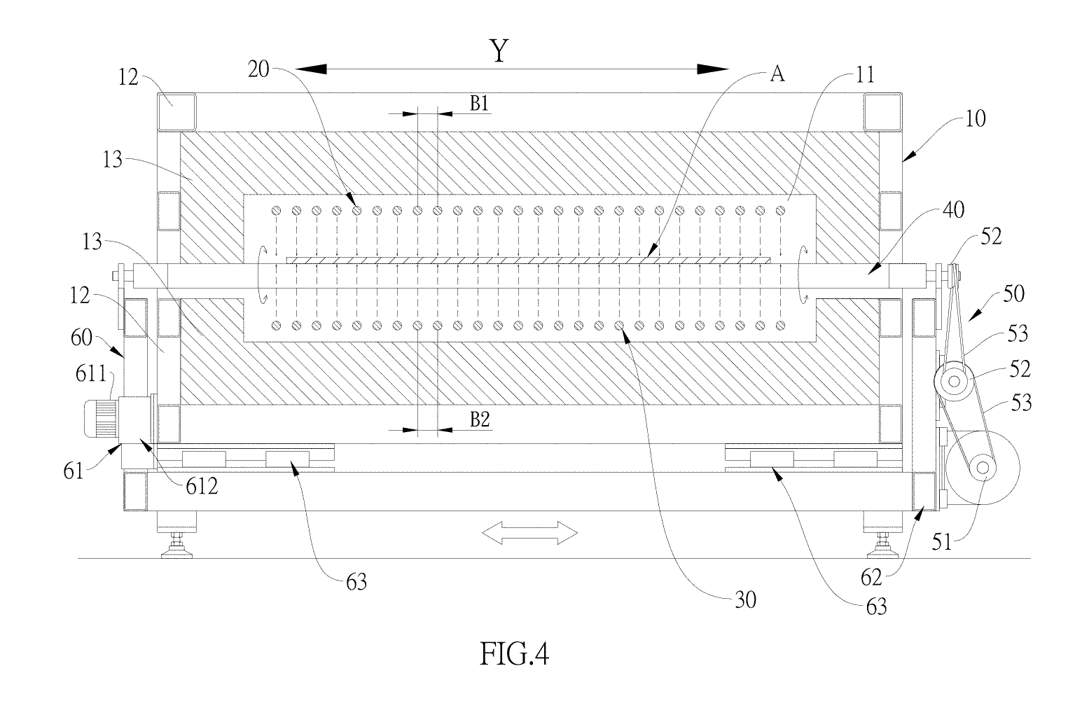

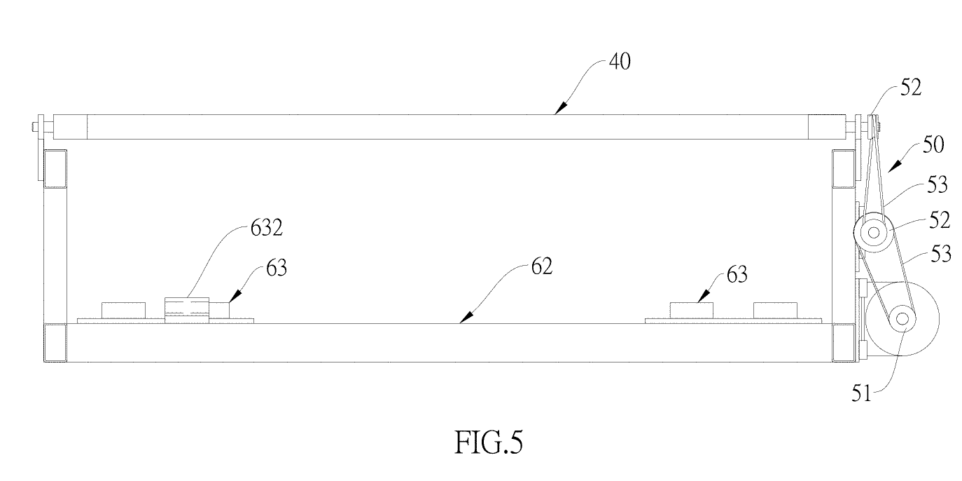

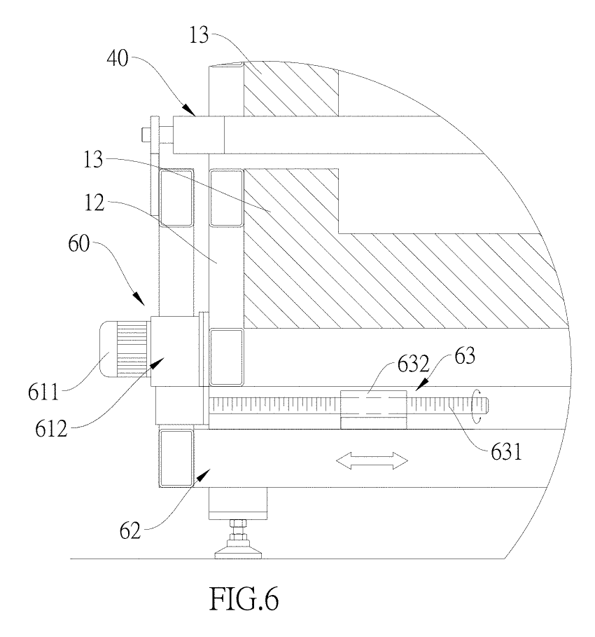

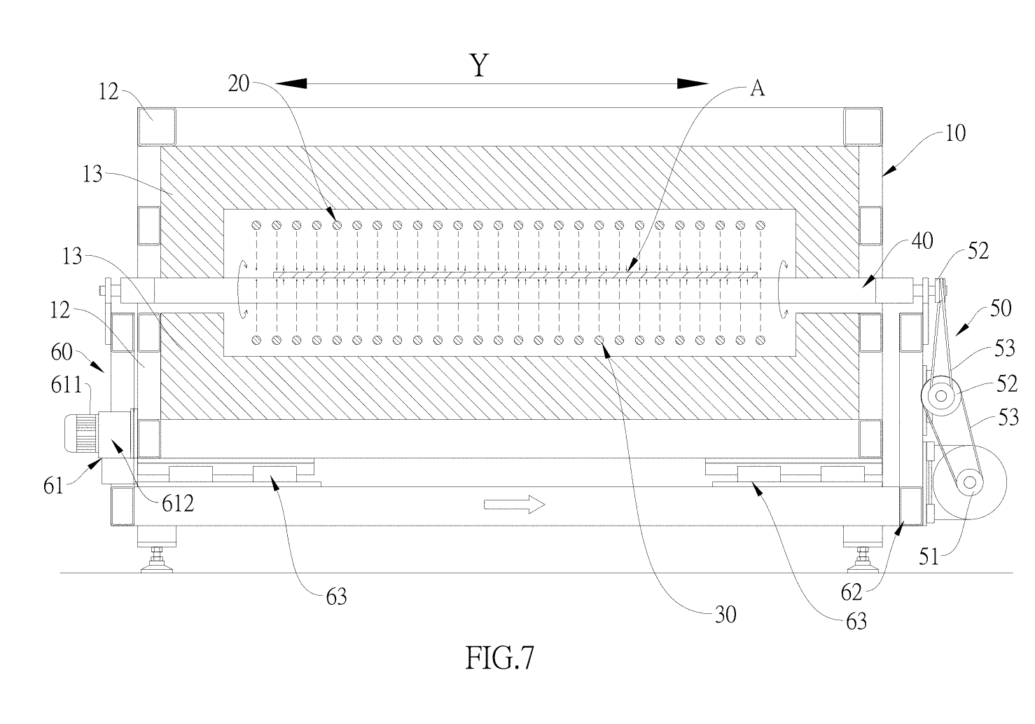

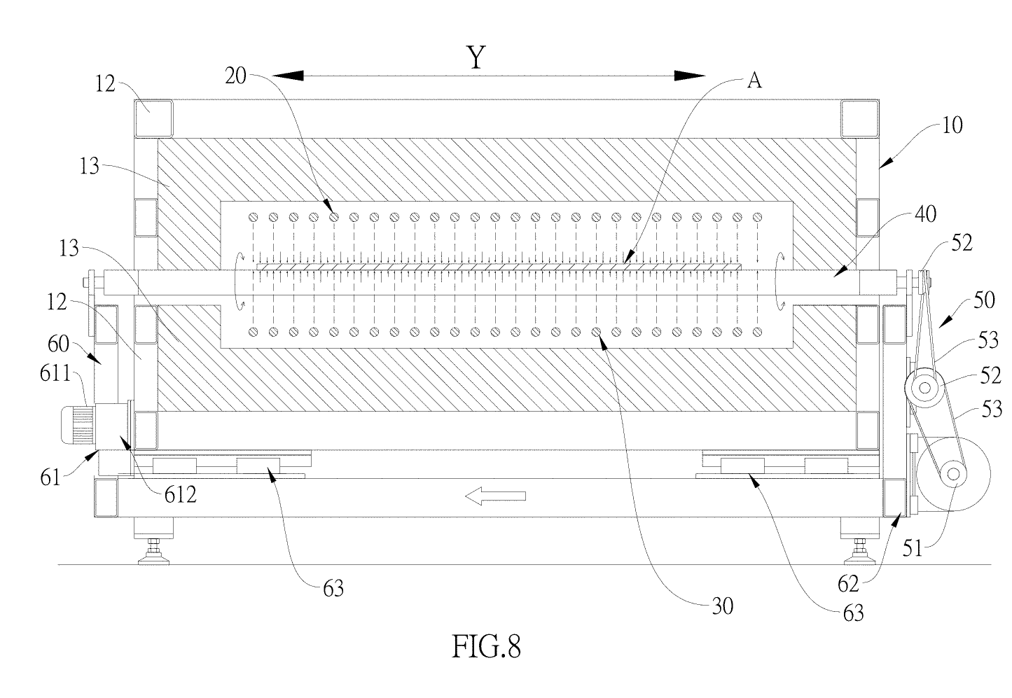

Referring to FIGS. 3 to 8, it shows respectively a first schematic view, a second schematic view, a third schematic view, a fourth schematic view, a fifth schematic view and a sixth schematic, according to an embodiment of a glass heating furnace of the present invention. The glass heating furnace disclosed by the present invention comprises a furnace body 10, plural upper heating elements 20, plural lower heating elements 30, plural rollers 40, a first roller power module 60 and a second roller power module 50.

The furnace body 10 includes a rack 12, an interior of the rack 12 is surrounded by a heat insulation layer 13, and a chamber 11 is formed in the heat insulation layer 13.

The plural upper heating elements 20 are disposed in the chamber 11, and each upper heating element 20 includes a ceramic tube 21 and a fixed base 22. The ceramic tube 21 is connected with the fixed base 22, and the fixed base 22 can be connected with and fixed on the rack 12 by screws or welding. Preferably, the upper heating elements 20 are disposed in intervals, and the center of one upper heating element 20 is separated with the center of a neighboring upper heating element 20 by a first distance B1 of 5˜13 cm.

The lower heating elements 30 are disposed in the chamber 11 and are located oppositely below the upper heating elements 20. Each lower heating element 30 includes another ceramic tube 31 and another fixed base 32. The ceramic tube 31 is connected with the fixed base 32, and the fixed base 32 is connected with and fixed on the rack 12 by screws or welding. Preferably, the lower heating elements 30 are disposed in intervals, and the center of one lower heating element 30 is separated with the center of a neighboring lower heating element 30 by a second distance B2 of 5˜13 cm.

The rollers 40 are disposed in intervals in the chamber 11 along a transversal axis X and are located between the upper heating elements 20 and the lower heating elements 30. The transversal axis X is perpendicular to the axis of the rollers 40, and the center of one roller 40 is separated with the center of a neighboring roller 40 by a preferred third distance C of 8˜20 cm. The rollers 40 can be, but not limited to be, parallel or perpendicular to the upper heating elements 20 or the lower heating elements 30. In the present embodiment, the rollers 40 are designed to be perpendicular to the upper heating elements 20 and the lower heating elements 30. These rollers 40 can be used to carry glass A to be heated up.

The first roller power module 60 is disposed outside the furnace 10 and is connected with the rollers 40. The rollers 40 are controlled by the first roller power module 60 to displace reciprocatively between two pre-determined positions along a longitudinal axis Y which is the axis of the rollers 40. The longitudinal axis Y is perpendicular to the transversal axis X, meaning that the first roller power module 60 and the rollers 40 drive the glass A carried by the rollers 40 to displace reciprocatively along the longitudinal axis Y.

The first roller power module 60 includes at least a moving mechanism 61 and a moving frame 62. The moving frame 62 is connected with the rollers 40, the moving mechanism 61 includes a motor 611 which can rotate clockwise and counterclockwise and a decelerator 612 which can reduce the rotating speed and increase the torque in order to push the moving frame 62 to displace reciprocatively along the longitudinal axis Y, thereby driving the rollers 40 which are connected with the moving frame 62 to displace reciprocatively along the longitudinal axis Y and enabling the glass A which is carried by the rollers 40 to displace reciprocatively along the longitudinal axis Y.

In the present embodiment, the first roller power module 60 can even include a slide assembly 63, the moving mechanism 61 is disposed on the moving frame 62, and the slide assembly 63 is connected with the moving frame 62 and the furnace body 10. The slide assembly 63 includes a threaded rod 631 and a threaded block 632, the threaded rod 631 and the threaded block 632 can be gnawed with each other, and the axis of the threaded rod 631 is the longitudinal axis Y.

In the embodiment wherein the threaded block 632 is fixed with the furnace body 10, the motor 611 that can rotate clockwise and counterclockwise and the decelerator 612 that can reduce the rotating speed and increase the torque, of the moving mechanism 61, drive the threaded rod 631 to rotate. As the threaded block 632 is fixed with the furnace body 10, the threaded block 632 cannot move, which forces the threaded rod 631 and the motor 611 to displace reciprocatively following the clockwise rotation and the counterclockwise rotation of the motor 611, causing the moving mechanism 61 to displace reciprocatively along the longitudinal axis Y. In addition, as the moving mechanism 61 is disposed on the moving frame 62, the moving frame 62 also displaces reciprocatively along the longitudinal axis Y, which also results in that the rollers 40 that are connected with the moving frame 62 displace reciprocatively along the longitudinal axis Y, and allows the glass A that is carried by the rollers 40 to displace reciprocatively along the longitudinal axis Y.

In the embodiment wherein the threaded rod 631 is fixed with the furnace body 10, the motor 611 that can rotate clockwise and counterclockwise and the decelerator 612 that can reduce the rotating speed and increase the torque, of the moving mechanism 61, drive the threaded block 632 to rotate. As the threaded rod 631 is fixed with the furnace body 10, the threaded rod 631 cannot move, which forces the threaded block 632 and the motor 611 to displace reciprocatively following the clockwise rotation and the counterclockwise rotation of the motor 611, causing the moving mechanism 61 to displace reciprocatively along the longitudinal axis Y. In addition, as the moving mechanism 61 is disposed on the moving frame 62, the moving frame 62 also displaces reciprocatively along the longitudinal axis Y, which also results in that the rollers 40 that are connected with the moving frame 62 displace reciprocatively along the longitudinal axis Y, and allows the glass A that is carried by the rollers 40 to displace reciprocatively along the longitudinal axis Y.

The abovementioned rollers 40 can displace reciprocatively between the two pre-determined positions along the longitudinal axis Y under the control of the first roller power module 60. In the present embodiment, the rollers 40 are perpendicular to the upper heating elements 20 and the lower heating elements 30, and the distance between the two pre-determined positions is at least one fourth of the first distance B1 or at least one fourth of the second distance B2. Preferably, the distance between the two pre-determined positions is at least one third of the first distance B1 or at least one third of the second distance B2. It is even better that the distance between the two pre-determined positions is at least one half of the first distance B1 or at least one half of the second distance B2. Moreover, it is best that the distance between the two pre-determined positions is not smaller than the first distance B1 or not smaller than the second distance B2.

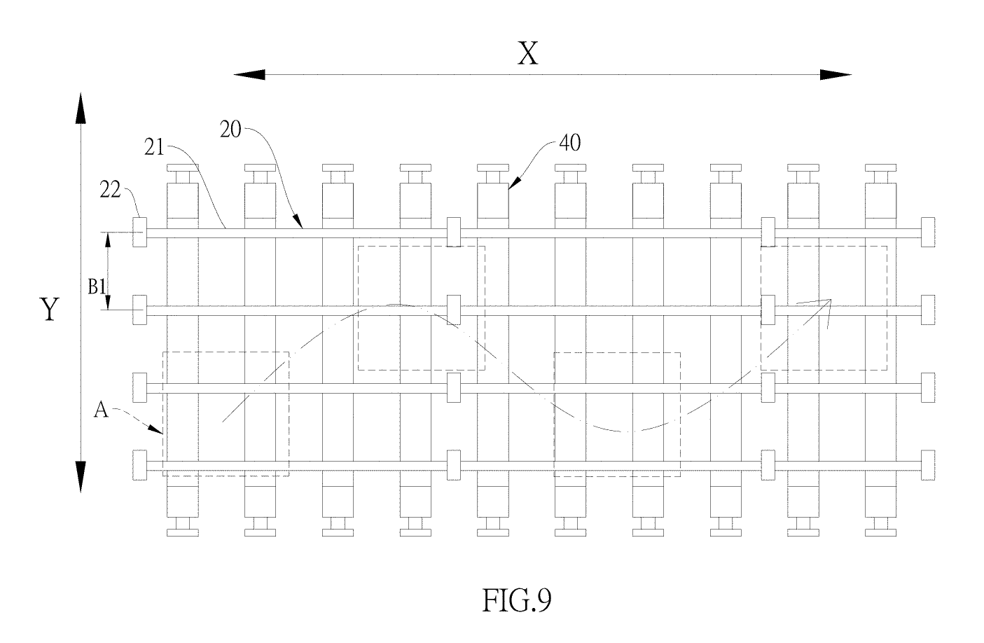

When the glass A is transmitted in a single direction for processing toward the outlet of the chamber 11 along the transversal axis X from the inlet of the chamber 11 by the rollers 40, as the first roller power module 60 drives the glass A to displace reciprocatively along the longitudinal axis Y, the glass A will displace along an S-shaped moving path, as shown in FIG. 9. This means that the moving path of the glass A in the chamber 11 is like an English letter of S. By the S-shaped moving path of the glass A, the glass A is carried by the rollers 40 and can displace reciprocatively along the longitudinal axis Y within the first distance B1 between the two neighboring upper heating elements 20, thereby allowing the glass A to be heated up uniformly, which reduces effectively the formation of the thermal stress marks on the glass A.

The second roller power module 50 is disposed outside the furnace body 10 and is connected with the rollers 40. The rollers 40 can rotate clockwise and counterclockwise under the control of the second roller power module 50, driving the glass A to displace reciprocatively along the transversal axis X. More specifically, the second roller power module 50 includes at least a turning gear 51, plural transmission wheels 52 and plural round belts 53. The turning gear 51 is connected with one transmission wheel 52, and the transmission wheels 52 are connected with one another by the round belts 53; whereas, at least one transmission wheel 52 is connected with the rollers 40. The turning gear 51 can rotate clockwise and counterclockwise to drive one transmission wheel 52 to rotate clockwise and counterclockwise. That transmission wheel 52 then drives other transmission wheels 52 to rotate clockwise and counterclockwise through the round belts 53, thereby allowing the transmission wheel 52 that is connected with the rollers 40 to drive the rollers 40 to rotate clockwise and counterclockwise, so that the glass A that is carried by the rollers 40 can displace reciprocatively along the transversal axis X. Each roller 40 can be designed as a barrel and can be made of glass, ceramic or quartz.

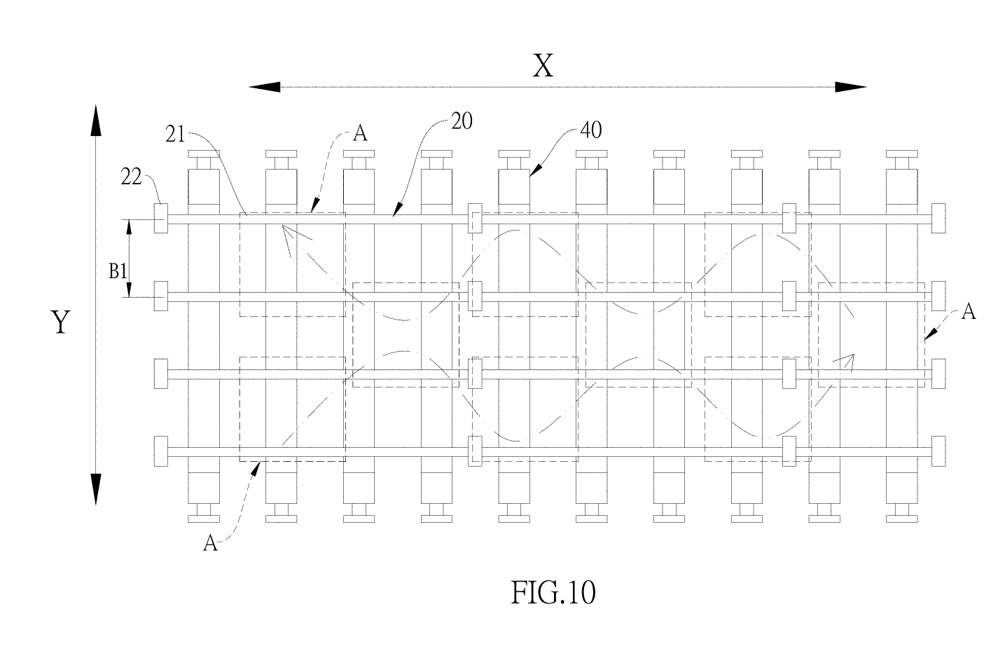

According to the abovementioned descriptions, the first roller power module 60 enables the glass A to displace reciprocatively along the longitudinal axis Y; whereas the second roller power module 50 enables the glass A to displace reciprocatively along the transversal axis X. When the glass A is transmitted in a single direction for processing toward the outlet of the chamber 11 along the transversal axis X from the inlet of the chamber 11 by the rollers 40, as the first roller power module 60 drives the glass A to displace reciprocatively along the longitudinal axis Y, and the second roller power module 50 drives the glass A to displace reciprocatively along the transversal axis X, the glass A will displace along an 8-shaped moving path, as shown in FIG. 10. This means that the moving path of the glass A in the chamber 11 is like a number of 8. By the 8-shaped moving path of the glass A, the glass A is carried by the rollers 40 and can displace along the 8-shaped moving path within the first distance B1 between the two neighboring upper heating elements 20, thereby allowing the glass A to be even heated up uniformly and further reducing effectively the formation of the thermal stress marks on the glass A.

Accordingly, the glass heating furnace of the present invention is provided with two roller power modules 60, 50 at a same time to control the rollers 40 to rotate clockwise and counterclockwise, and control the rollers 40 to displace reciprocatively along the longitudinal axis Y, so that the glass A can be driven to displace along the S-shaped moving path or the 8-shaped moving path, thereby enabling the glass A to be heated up more uniformly and reducing the formation of the thermal stress marks on the glass A.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A glass heating furnace comprising
a furnace body, an interior of which is formed with a chamber;
plural upper heating elements, which are disposed in the chamber, with the center of one upper heating element being separated with the center of a neighboring upper heating element by a first distance;
plural lower heating elements, which are disposed in the chamber and are located oppositely below the upper heating elements, with the center of one lower heating element being separated with the center of a neighboring lower heating element by a second distance;
plural rollers, which are disposed in the chamber along a transversal axis and are located between the upper heating elements and the lower heating elements, with the transversal axis being perpendicular to a longitudinal axis and that longitudinal axis being the axis of the rollers; and
a first roller power module, which is disposed outside the furnace body and is connected with the rollers, with the first roller power module controlling the rollers to displace reciprocatively between two pre-determined positions along the longitudinal axis.

2. The glass heating furnace according to claim 1, wherein the distance between the two pre-determined positions is at least one fourth of the first distance or at least one fourth of the second distance.

3. The glass heating furnace according to claim 1, wherein the distance between the two pre-determined positions is at least one third of the first distance or at least one third of the second distance.

4. The glass heating furnace according to claim 1, wherein the distance between the two pre-determined positions is at least one half of the first distance or at least one half of the second distance.

5. The glass heating furnace according to claim 1, wherein the distance between the two pre-determined positions is not smaller than the first distance or not smaller than the second distance.

6. The glass heating furnace according to claim 1, wherein the first roller power module includes at least a moving mechanism and a moving frame, the moving mechanism is disposed on the moving frame, the moving frame is connected with the rollers, and the moving mechanism includes a motor which rotates clockwise and counterclockwise as well as a decelerator which reduces the rotating speed and increases the torque.

7. The glass heating furnace according to claim 1, wherein the first roller power module includes at least a moving mechanism and a moving frame, the moving frame is connected with the rollers, the moving mechanism includes a motor and a decelerator, and the motor and the decelerator are connected with the moving frame by a slide assembly.

8. The glass heating furnace according to claim 6, wherein the first roller module further includes a slide assembly which is connected with the moving frame and the furnace body.

9. The glass heating furnace according to claim 8, wherein the slide assembly includes a threaded rod and a threaded block, the threaded rod and the threaded block are gnawed with each other, and the axis of the threaded rod is the longitudinal axis.

10. The glass heating furnace according to claim 8, wherein the threaded rod is fixed with the furnace body.

11. The glass heating furnace according to claim 8, wherein the threaded block is fixed with the furnace body.

12. The glass heating furnace according to claim 1, further comprising a second roller power module which is disposed outside the furnace body and is connected with the rollers.

13. The glass heating furnace according to claim 12, wherein the second roller power module includes a turning gear, plural transmission wheels and plural round belts, the turning gear is connected with at least one transmission wheel, the transmission wheels are connected with one another through the round belts, at least one transmission wheel is connected with the rollers, and the turning gear rotates clockwise and counterclockwise.

14. The glass heating furnace according to claim 1, wherein the rollers are parallel or perpendicular to the upper heating elements or the lower heating elements.

15. The glass heating furnace according to claim 1, wherein the rollers are perpendicular to the upper heating elements and the lower heating elements.

16. A glass, which is made by the glass heating furnace according to claim 1.

17. The glass according to claim 16, wherein the moving path of the glass in the chamber is like an English letter of S.

18. The glass according to claim 16, wherein the moving path of the glass in the chamber is like a number of 8.
